(19) United States
(12) Patent Application Publication
(10) Pub. No.: US 2009/0084628 A1
(43) Pub. Date: Apr. 2, 2009

(54) LADDER WITH INCORPORATED SOUND SYSTEM

(76) Inventor: Jolene Smith, Dublin, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/865,972

(22) Filed: Oct. 2, 2007

(51) Int. Cl. E06C 7/00; E06C 1/00

(52) U.S. Cl. 182/129; 182/194

(57) ABSTRACT

A ladder including a sound system comprising a at least one pair of generally parallel legs, a plurality of steps extending between said pair of legs, and a sound system mounted between said pair of legs near the top thereof, the sound system including a media player, and at least one speaker operably connected thereto.

### BACKGROUND OF THE INVENTION

A. Field of the Invention

The invention broadly relates to a ladder that has a sound system integrated into it. The sound system includes, but is not limited to, a radio, DVD or CD player, MP3 player. iPod or similar device, battery or other power source, amplifiers and speaker(s).

B. Prior Art

Many types of ladders have been provided in the prior art, For example, Brown (U.S. Pat. No. 5,971,102) discloses a ladder that includes a storage compartment and/or toolbox positioned adjacent to the work area, including a storage cabinet and a device for retaining a tool easily accessible to the user.

Smith (U.S. Pat. No. 5,603,405) discloses a ladder top storage rack that includes a rigid tool box securable to a ladder top. Smith also discloses a pair of side pouches secured to the walls of the tool box.

Joseph (U.S. Pat. No. 5,603,405) discloses an apparatus that attaches to the top platform of a stepladder. The apparatus includes a plate mounted to the stepladder, and a bucket receptacle disposed on top of the plate. The bucket receptacle is used to hold items such as paint cans, nails or cleaning implements therein.

While these devices fulfill their respective objectives and requirements, the aforementioned patents do not describe a ladder that incorporates a sound system.

In this respect, the ladder with incorporated sound system substantially departs from the conventional concepts and designs of the prior art, and in doing so provides an apparatus that allows the user to listen to and control music or other media while working on or near the ladder without having to use a separate sound system, and without the need to climb or descend the ladder to do so. Therefore, it can be appreciated that there exists a continuing need for a ladder with an incorporated or integrated sound system that allows the user to listen to the music or other media while working on or near the ladder. In this regard, the present invention substantially fulfills this need.

As used herein, the term “ladder” refers to an apparatus having at least two substantially parallel legs connected by a plurality of rungs or steps spanning the space between the legs, and providing means for a person to climb the ladder from the bottom step or rung, to the top. The term is also intended to encompass self supporting ladders, e.g. step ladders, and extension ladders.

### BRIEF SUMMARY OF THE INVENTION

The present invention comprises an improved ladder that includes an integrated sound system. As such, the general purpose of the present invention, which will be described subsequently in greater detail, is to provide a new and improved ladder that incorporates a sound system into its structure that may include a radio, DVD or CD player, MP3 player, iPod, or other digital source, battery, solar, or other power source, an amplifier, and one or more speakers.

Ladders come in many forms. The various forms include simple ladders, step ladders, and extension ladders. Simple ladders comprise a pair of generally parallel legs connected by a plurality of rungs, or steps. Step ladders normally comprise two sets of parallel legs, hinged, or connected at the top so that the ladder is self supporting when the second set of legs is extended outward. Extension ladders comprise a pair of individual ladders slideably positioned with respect to another, so that the overall length of the extension ladder can be expanded by a distance substantially equivalent to the length on one of the individual ladders.

Conventional ladders range from 6 to 15 feet in length, and extension ladders can extend over 30 feet in length. Thus ascending and descending a ladder can be dangerous, inconvenient, and time consuming. A ladder with an incorporated sound system at or near the top would allow a user to access a radio, DVD or CD player, MP3, or iPod device while staying at work on the ladder. This would minimize the number of times a worker climbs up and down the ladder during the day, or work period. Preferably, the ladder and the incorporated sound system device will be durable and resistant to damage from the elements, as well as the rigors of use in rough conditions.

The present invention, therefore, is an apparatus comprising a ladder and an incorporated sound system mounted near the top thereof. The sound system includes one or more media sources such as a radio, tape or DVD or CD player, iPod and/or MP3 player, a sound amplifier, one or more speakers, and a power source such as a battery or solar device. Preferably, although not a necessary element of the invention, the controls to the sound system will be accessible via a touch pad on or near the top step of the ladder. During typical use, the user does not stand on the top step (for safety reasons). Therefore, the top step is the most convenient location to access the sound system controls.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

### BRIEF DESCRIPTION OF THE DRAWINGS

FIG. 1A is a perspective view of the of the ladder of the invention showing the sound system component thereof mounted below the top step of the ladder spanning the two legs.

FIG. 1B is an enlarged view of section 1B of FIG. 1A.

FIG. 2 is a perspective view of an alternate embodiment of the invention.

### DETAILED DESCRIPTION OF THE INVENTION

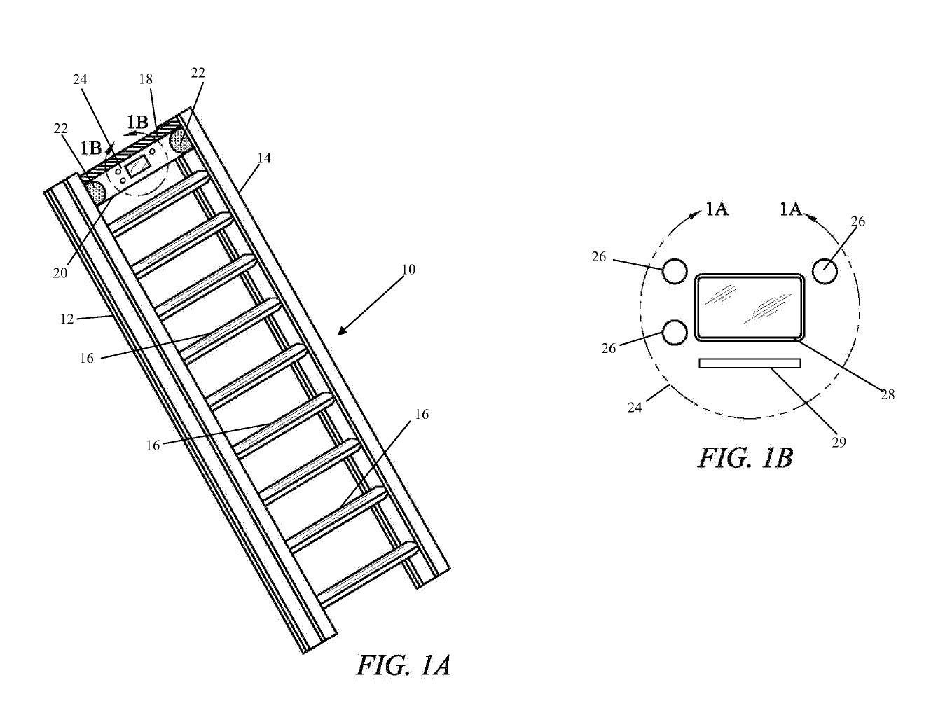

One embodiment of the ladder of this invention is seen in FIG. 1A. The ladder 10 comprises a pair of parallel legs 12 and 14 connected by a plurality of steps or rungs 16 which extend there between.

As shown, the legs 12 and 14 comprise elongated U-shaped channels, but other configurations can be used. The steps 16 can be spaced apart any desired distance, but, conventionally will be about 8 inches apart which is the normal rise in a step. Situated at or near the top of the ladder 10 is the sound system component 18 of the invention. FIGS. 1A and 1B show the sound system component 18 comprising an elongated box 20 having speakers 22 mounted at each end. In the middle of the box 20 is situated a sound generating media device 24 which can be a AM/FM radio, a satellite radio, a DVD or CD player, an MP3 player, or any other device capable of generating sound such as an I-pod, or even a combination telephone—sound generator. The media device contains knobs 26 for adjusting the volume, and/or selecting a station if the device is a radio. It can also have a touch pad controller 28 for adjusting the sound, etc., if desired.

As used herein, the term MP3 player refers to a digital device capable of receiving wireless transmitted signals from the ether, or digital signals from a computer, and converting them into sound. MP3 players are well known in the art, and are made by a number of manufacturers. The term iPod refers to a brand of portable media players designed and manufactured by the Apple Corporation, Cupertino, Calif.,

The MP3 or I-POD devices can be inserted into a slot 29 in the box 20, and connected to an amplifier (not shown) and speakers 22 in the box 20.

The sound system 18 is powered by a battery, not shown. A solar panel for generating power can also positioned on the top plate of step of the ladder to supplement the battery.

In use, a workman or user of the ladder 10 places the ladder against a wall or other support, climbs the ladder 10 and then turns the sound system component 18 on, selecting the desired station if the media device is a radio, or selecting music from a CD, or downloaded music if it is an MP3 player, an I-pod, or the like.

The legs 12, 14, and steps 16 of the ladder 10 of the invention can be made of any convention material, such as aluminum, or wood. What is required is that the structural material be strong enough to support the weight of a user or person who climbs the ladder for any reason.

Also, while the ladder shown in FIG. 1A is a conventional straight ladder, with parallel legs, other types can be used. Ladders with legs that are spaced apart further at the bottom than at the top are also suitable for use. Thus, ladders with substantially parallel legs are included within the purview of this invention.

Whatever form the ladder takes, the sound system is incorporated into it at or near the top step or rung for ease of use. The box 20 containing the speakers 22, amplifier, battery, and sound generator 24, can be attached to the legs 12, 14, by appropriate screws.

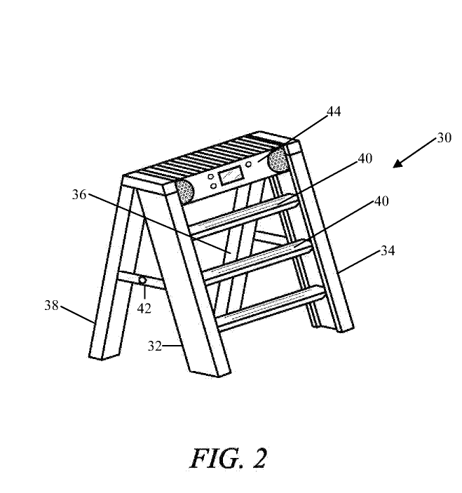

Another embodiment of the invention is a step ladder with the sound system incorporated therein. This embodiment is shown in FIG. 2, wherein the step ladder 30 comprises a first pair of legs 32, 34 hinged at the top to a second pair of legs 36, 38. The first pair of legs 32, 34 are connected by steps 40 spanning the space between the legs 32, 34. A foldable hinged strut 42 connects opposing sets of legs to supply support. The sound system component 44 of this embodiment of the invention is positioned at or near the top step 40 spanning the legs 32, 34. The sound system component 44 is essentially the same as that shown and described in connection with FIGS. 1A, and 1B.

It is to be understood that the invention is not limited in its application to the details of construction and to the arrangements of the components set forth in the above description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the abstract set forth herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A ladder including sound system comprising:
a. a pair of generally parallel elongated legs;
b. a plurality of steps extending between said pair of legs; and
c. a sound system mounted between said pair of elongated legs near the top step thereof.

2. The ladder of claim 1 wherein said sound system comprises:
a. a media player capable of providing audio content; and
b. one or more speakers operably connected to said media player.

3. The invention of claim 1, further comprising a battery capable of powering the sound system.

4. The invention of claim 1, further comprising a solar device capable of powering the sound system.

5. The invention of claim 2, wherein the media player capable of providing audio content is an AM/FM radio.

6. The invention of claim 2, wherein the media player capable of providing audio content is a satellite radio.

7. The invention of claim 2, wherein the media player capable of providing audio content is a compact disc player.

8. The invention of claim 2, wherein the media player capable of providing audio content is an MP3 player.

9. The invention of claim 2, wherein said media player is an iPod device.

10. The invention of claim 2, further comprising a touch pad controller capable of controlling the media player.

11. The invention of claim 10 wherein the touch pad controller is located on the top step of the ladder.

12. A ladder including sound system comprising:
a. a first pair of legs;
b. a second pair of legs extending at an adjustable angle relative to said first pair of legs;
c. a plurality of steps extending between said legs of said first pair of legs;
d. a media player capable of providing audio content; and
e. one or more speakers operably connected to said media player.

13. The invention of claim 12, further comprising a battery capable of powering the sound system.

14. The invention of claim 12, further comprising a solar device capable of powering the sound system.

15. The invention of claim 12, wherein the media player capable of providing audio content is an AM/FM radio.

16. The invention of claim 12, wherein the media player capable of providing audio content is a satellite radio.

17. The invention of claim 12, wherein the media player capable of providing audio content is a compact disc player.

18. The invention of claim 12, wherein the media player capable of providing audio content is an MP3 player.

19. The invention of claim 12, wherein said media player is an iPod device.

20. The invention of claim 12, further comprising a touch pad controller capable of controlling the media player.

21. The invention of claim 10 wherein the touch pad controller is located on the top step of the ladder.
